(19) United States
(12) Patent Application Publication
(10) Pub. No.: US 2009/0245400 A1
(43) Pub. Date: Oct. 1, 2009

(54) METHOD FOR SELECTION OF ERROR-CORRECTION CODE IN MIMO WIRELESS COMMUNICATION SYSTEMS

(75) Inventors: Jiunn-Tsair Chen, Hsinchu (TW); Cheng-Hsuan Wu, Hsinchu (TW); Yai-Nan Lee, Hsinchu (TW)

Correspondence Address: EDWARDS ANGELL PALMER & DODGE LLP, P.O. BOX 55874, BOSTON, MA, 02205, US

(73) Assignee: RALINK TECHNOLOGY CORPORATION, Hsinchu (TW)

(21) Appl. No.: 12/362,054

(22) Filed: Jan. 29, 2009

(30) Foreign Application Priority Data
Mar. 25, 2008 (TW) 097110478

(51) Int. Cl. H04L 27/28; H04L 1/02

(52) U.S. Cl. 375/260; 714/746

(57) ABSTRACT

A method that selects an error-correction code for use in a multiple-input multiple output (MIMO) wireless communication system is disclosed that optimizes the performance of the MIMO wireless communication system. The method selects the error-correction code according to at least one system parameter and at least one channel parameter of the MIMO wireless communication system, such that the selected error-correction code matches the hardware configuration and channel setting of the MIMO wireless communication system.

### BACKGROUND OF THE INVENTION

1. Field of the Invention

The present invention relates to error-correction code selection methods, and more particularly, to a method for selection of an error-correction code for use in a MIMO wireless communication system.

2. Description of Related Art

Among all the techniques that provide error-free data transmission in modern communication system, error-correction code techniques play a crucial role in such systems. This is the case whether utilized within a self-contained non-radio frequency digital device such as a CD and DVD player, or with current digital satellite broadcasting and future digital broadcasting and digital TV. In addition, various computer memory storage devices (e.g. RAM, ROM, HD, and CD-ROM), arithmetic logic units as well as the Internet data encoding format utilize error-correction schemes to enhance the reliability and integrity of messages.

During that last 10 years, a technique known as the low-density parity check (LDPC) error-detection and correction coding scheme has become extremely important in data transmission for both detecting and correction errors caused by noisy communication channels. The basis for such a coding scheme was first developed in the 60's but, until recently, a lack of processing power—particularly on the decoding end—made implementing such a scheme impractical. The LDPC scheme involves the sender and the receiver agreeing on the use of a so-called code that comes from parity equations that are created to detect and correct errors. Various such codes are possible, although their performance may vary. After agreeing on a single particular code, this one code is then repeatedly applied to encode a stream of digital data packets on a one-by-one basis prior to transmission and then to decode such a stream of packets upon reception, whereupon such a code is used to detect and correct transmission errors within the data packets in order to greatly improve the reliability of data transmission over a noisy communication channel.

The inventor of the present invention has published a thesis on the “Design of LDPC-Coded MIMO Systems via a Large-System Approach” which appears on pages 543 to 545 of the “IEEE Communication Letters, vol. 10” issued in July 2006. This thesis investigates the selection of an error-correction code based on the ratio, ρ, of the number of transmitting antennas M to the number of receiving antennas N in a multiple-input multiple-output MIMO wireless communication system so as to reach the maximum efficiency of the MIMO wireless communication system, thereby achieving the optimal effect. The above-mentioned thesis discloses a MIMO wireless communication system that selects the same error-correction code given the same antenna ratio, ρ. For example, when M/N=4/4 (wherein there are 4 transmitting antennas and 4 receiving antennas), the selected error-correction code will be the same as that of when M/N=2/2 (wherein there are 2 transmitting antennas and 2 receiving antennas).

However, after further investigation performed by the inventor of the present invention, the disclosure of the error-correction code selection method in the above-mentioned thesis is only appropriate under the ideal conditions of a “low-scattering” communication environment, referring to an open space without signal path obstructions. However, such environments are only possible in rural areas with sparse populations and development. In a densely populated urban area, radio transmission waves are often distorted by obstructions such as high-rise buildings. Such an urban area is not a low-scattering environment; instead, such an urban area is a so-called “rich-scattering” environment. As such, the method of selecting the error-correction code based on the antenna ratio is obviously not suitable for use in such above-mentioned rich-scattering environments.

### SUMMARY OF THE INVENTION

In view of the above drawbacks of the conventional technique, a primary objective of the present invention is to provide a method of selecting an error-correction code in a multiple-input multiple-output wireless communication system, such that the selected error-correction code is suitable for use in a variety of communication environments, thereby optimizing the system efficiency.

In order to achieve the above-mentioned objective, the present invention provides a method of selecting an error-correction code in a multiple-input multiple-output wireless communication system. The MIMO wireless communication system includes an input module and an output module, wherein the input module has N receiving antennas and the output module has M transmitting antennas. In addition, at least one of N and M is an integer that is greater than 1. The method includes: determining at least one system parameter in the MIMO wireless communication system, wherein the system parameter relates to the hardware setting of the MIMO wireless communication system; determining at least one channel parameter in the MIMO wireless communication system, wherein the channel parameter relates to the communication channel between the input module and the output module; and selecting an error-correction code among a plurality of built-in error-correction codes in the MIMO wireless communication system based on at least one system parameter and at least one channel parameter, thereby allowing data encoding and decoding based on the error-correction code selected by the MIMO wireless communication system.

Selection of the appropriate error-correction code optimizes the efficiency of the MIMO wireless communication system. The error-correction code is selected based on the system parameter as well as the channel parameter of the MIMO wireless communication system such that the selected error-correction code complies with the hardware setting and the channel of the MIMO wireless communication system.

### BRIEF DESCRIPTION OF DRAWINGS

FIG. 1 is a functional block diagram of a MIMO wireless communication system that adopts the method of the present invention to select an error-correction code;

FIG. 2 is a functional block diagram of an output module and an input module in the MIMO wireless communication system of FIG. 1; and

FIG. 3 is a flow chart of the method of selecting the appropriate error-correction code according to the present invention.

### DETAILED DESCRIPTION OF PREFERRED EMBODIMENTS

The following illustrative embodiments are provided to illustrate the disclosure of the present invention. These and other advantages and effects can be apparently understood by those in the art after reading the disclosure of this specification. The present invention can also be performed or applied by other differing embodiments. The details of the specification may be changed on the basis of different points and applications, and numerous modifications and variations can be devised without departing from the spirit of the present invention.

As the inventor of the present invention further investigated the method for error-correction code selection in the above-mentioned thesis, the most important part to be improved upon was to include factors related to the communication channel such that the selected error-correction code is not only suitable for the system hardware setting but also suitable for use by the system in the communication channel established, so as to respond to the varying communication channel. Hence, in order to modify the prior art, which only considers the antenna ratio when selecting an error-correction code without regard to the communication channel, the present invention takes into account the whole MIMO wireless communication system and its established communication channel, thereby allowing the selected error-correction code to not only comply with the system hardware settings, but at the same time also be for use in different communication channels and environments.

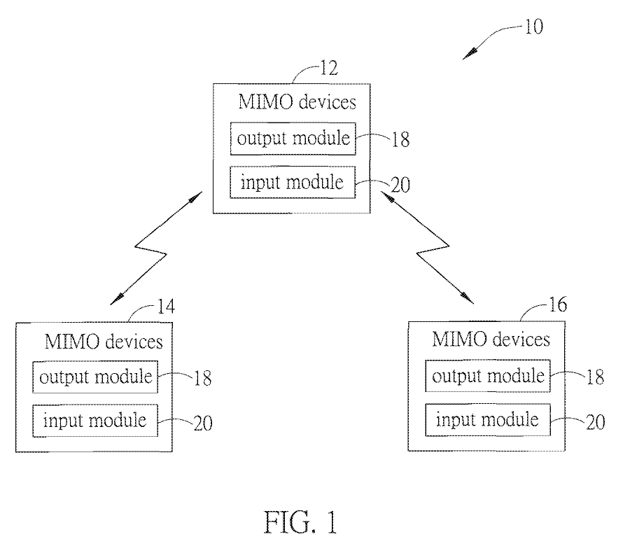

In order to achieve the above objective, the present invention selects an appropriate error-correction code based on at least one system parameter and one channel parameter of the MIMO wireless communication system. FIG. 1 is a functional block diagram illustrating the method of selecting an error-correction code in a MIMO wireless communication system 10 according to the present invention. The MIMO wireless communication system 10 includes a plurality of MIMO devices 12, 14 and 16, wherein each of the MIMO devices 12, 14 and 16 has an output module 18 and an input module 20. The output module 18 serves to transmit wireless packets and the input module 20 serves to receive the wireless packets. It is to be noted that even though the present embodiment is explained using an example of a system having three MIMO devices, the method disclosed in the present invention is also suitable for use in systems with only two devices or with more than three devices. In addition, in the present embodiment, each of the MIMO devices 12, 14, and 16 is configured with the same output module 18 and input module 20 for the convenience of explanation. However, it is to be noted that the method disclosed in the present invention is also suitable for use on other MIMO devices with different output and/or input modules. For instance, the output modules on the MIMO devices are allowed to have different numbers of transmitting antennas, and the input modules on the MIMO devices are likewise allowed to have different numbers of receiving antennas. The above straightforward variations are included within the scope of the present invention.

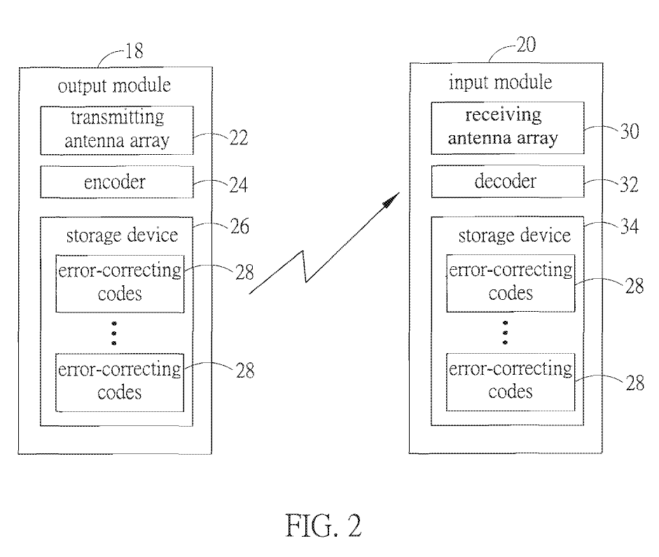

For the convenience of explanation, the following explains how wireless transmission is performed between each of the MIMO devices 12, 14 and 16, wherein every MIMO device includes only an output module 18 and an input module 20. FIG. 2 is a functional block diagram of the output module 18 and the input module 20 shown in FIG. 1, wherein, in the case of FIG. 2, the output module 18 and the input module 20 are separately constructed on different MIMO devices. In other words, the output module 18 and the input module 20 of FIG. 2 are not on the same MIMO device, even though each MIMO device has an input and output module. The output module 18 has a transmitting antenna array 22, and the input module 20 has a receiving antenna array 30, wherein the transmitting antenna array 22 is made up of M transmitting antennas for transmitting radio waves, and the receiving antenna array 30 is made up of N receiving antennas for receiving the radio waves transmitted by M transmitting antennas of the input module 18. Naturally, in that the system 10 is a MIMO wireless communication system, then at least one of N and M must be an integer that is greater than 1 by definition.

Prior to transmitting data from the output module 18 to the input module 20, the output module 18 encodes the data using an encoder 24. Before the encoder 24 starts to encode the data, the encoder 24 selects an error-correction code from a plurality of error-correction codes 28 saved in a storage device 26 of the output module 18. Subsequently, the encoder 24 encodes the data based on the selected error-correction code. When the encoder 24 completes the data encoding, a total of M transmitting antennas of the transmitting antenna array 22 then follow the MIMO communication protocol to transmit the encoded data to the input module 20 in the form of wireless packets. Subsequently, N receiving antennas of the receiving antenna array 30 of the input module 20 then receive the wireless packets transmitted from the transmitting antenna array 22. Upon receiving the wireless packets, the encoded data in the received wireless packets will be decoded by a decoder 32 of the input module 20, so as to restore the data encoded by the encoder 24. Before the decoder 32 proceeds with the decoding of the encoded data in the received wireless packets, the decoder 32 reads the appropriate error-correction code from a plurality of error-correction codes 28 saved in a storage device 34 of the input module 20. Subsequently, the encoded data in the received wireless packets is then decoded according to the read error-correction code 28.

In the present embodiment, the storage devices 26 and 34 are one selected from a group consisting of Electrically-Erasable Programmable Read-Only Memory (EEPROM), Flash Memory, and other non-volatile memories. In addition, the two sets of error-correction codes saved on the respective storage devices 26 and 34 are generally the same. In this way, the decoder 32 is then able to select the error-correction code 28 used by the encoder 24 to decode the encoded data in the received wireless packets. It is to be noted that the output signal of the output module 18 and the received input signal of the input module 20 are most likely to be different due to noise in the surrounding environment; thus, in order to correct the errors in the signal received by the input module 20, the decoder 32 will use the selected error-correction code 28 for the decoding process of the encoded data in the received wireless packets, so as to restore the original data prior to data encoding. In this way, data errors caused during data transmission are significantly reduced, and those in the art acquainted with the latest techniques should be familiar with data correction using such an error-correction code, thus the data correction itself is not elaborated on further herein.

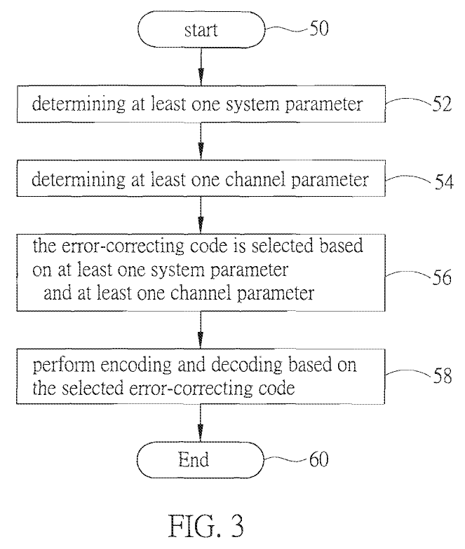

The following provides an explanation on how an appropriate error-correction code is selected according to the present invention. As shown in FIG. 3, a flow chart of the method 100 of selecting the error-correction code according to the present invention includes the following steps: in step 52, determine at least one system parameter of a MIMO wireless communication system 10; in step 54, determine at least one channel parameter of the MIMO wireless communication system 10; in step 56, based on the at least one system parameter determined in step 52 and the at least one channel parameter determined in step 54, select an error-correction code from a plurality of built-in error-correction codes 28; in step 58, perform an encoding operation using an encoder 24 of an output module 18 according to the selected error-correction code 28, and, after transmission and reception, perform a decoding operation using a decoder 32 of an input module 20 according to the selected error-correction code 28.

For the above steps, the system parameter relates to the hardware setting of the MIMO wireless communication system 10, such as number of the transmitting antennas M of a transmitting antenna array 22, the number of the receiving antennas N of a receiving antenna array 30, and so on. In addition, the channel parameter relates to a communication channel between the output module 18 and the input module 20, such as the rank of the channel matrix of the communication channel, data rate adopted by the communication channel, and so on. In particular, the method of calculating the rank of the channel matrix involves calculating the channel matrix of the communication channel according to the signal received by the input module 20, and, subsequently, the number of the independent row vectors of the channel matrix and the number of independent column vectors of the channel matrix are calculated. The rank of the channel matrix is equal to the smaller value of the independent row vector number and the independent column vector number. The following outlines a few preferred embodiments of the present invention for explanation.

According to an embodiment of the present invention, step 52 involves determining at least one system parameter of the MIMO wireless communication system 10, wherein it includes determining the number of transmitting antennas M of the transmitting antenna array 22 as well as the number of the receiving antennas N of the receiving antenna array 30. Subsequently, in step 56, based on the number of transmitting antennas M, the number of receiving antennas N and at least one channel parameter determined in step 54, an appropriate error-correction code is selected from a plurality of built-in error-correction codes 28.

In another embodiment of the present invention, step 52 determines at least one system parameter of the MIMO wireless communication system 10, wherein the ratio ρ of the number of transmitting antennas M to the number of receiving antennas N is included. Subsequently, in step 56, based on the ratio ρ and at least one channel parameter determined in step 54, an appropriate error-correction code is selected from a plurality of built-in error-correction codes 28.

According to another embodiment of the present invention, step 54 determines at least one channel parameter of the MIMO wireless communication system 10, including determining the rank of the channel matrix of the communication channel between the output module 18 and the input module 20. Subsequently, in step 56, based on the rank of the channel matrix and at least one system parameter determined in step 52, an appropriate error-correction code is selected from a plurality of built-in error-correction codes 28.

In another embodiment of the present invention, step 52 determines at least one system parameter of the MIMO wireless communication system 10, wherein determining the number of transmitting antennas M as well as the number of receiving antennas N is included. In addition, step 54 determines at least one channel parameter of the MIMO wireless communication channel 10, including determining the rank of the channel matrix of the communication channel between the output module 18 and the input module 20. Subsequently, in step 56, based on the number of transmitting antennas M, the number of receiving antennas N, and the rank of the channel matrix, an appropriate error-correction code is selected from a plurality of built-in error-correction codes 28.

In another embodiment of the present invention, step 56 includes determining the rank of the channel matrix of the communication channel between the output module 18 and the input module 20. Subsequently, the minimum value of the rank of the channel matrix, the number of the transmitting antennas M as well as the number of the receiving antennas N is found. Then, based on the minimum value, an appropriate error-correction code is selected from a plurality of built-in error-correction codes 28.

According to another embodiment of the present invention, step 56 includes determining the rank of the channel matrix of the communication channel between the output module 18 and the input module 20. Subsequently, the smaller value of the rank of the channel matrix and the number of transmitting antennas M is determined. Then, suppose that the smaller value of the rank of the channel matrix and the number of transmitting antennas M is denoted by P, then the value P corresponds to the number of the transmitting antennas M disclosed in the proposed thesis of the prior art, making ρ equal to P/N. In this way, using the method proposed in the above-mentioned thesis, an appropriate error-correction code is selected from a plurality of built-in error-correction codes 28 based on ρ, which is equal to P/N.

According to another embodiment of the present invention, step 56 includes determining the rank of the channel matrix of the communication channel between the output module 18 and the input module 20. Subsequently, the smaller value of the rank of the channel matrix and the number of receiving antennas N is determined. Then, suppose that the smaller value of the rank of the channel matrix and the number of receiving antennas N is denoted by P, then the value P corresponds to the number of the receiving antennas N disclosed in the proposed thesis of the prior art, making ρ equal to M/P. In this way, by using the method proposed in the above-mentioned thesis, an appropriate error-correction code is selected from a plurality of built-in error-correction codes 28 based on ρ, which is equal to M/P.

In comparison with the prior art where error-correction codes are selected based on the ratio ρ of the number of transmitting antennas M to the number of receiving antennas N, the present invention selects appropriate error-correction codes based on at least one system parameter and at least one channel parameter of the MIMO wireless communication system. Therefore, the MIMO wireless communication system that adopts the method of the present invention to select an error-correction code is able to select an appropriate error-correction code for use in places regardless of whether such places are low-scattering locations or rich-scattering locations, thereby maximizing the system efficiency as well as achieving the optimal effect.

The foregoing embodiments and advantages are merely exemplary and are not to be construed as limiting the present invention. It will be understood that variations and modifications can be effected thereto by those skilled in the art without departing from the spirit and scope of the invention as defined by the appended claims.

What is claimed is:

1. A method of selecting an error-correction code in a multiple-input multiple-output (MIMO) wireless communication system that comprises an input module having N receiving antennas and an output module having M transmitting antennas such that at least one of N and M is an integer greater than 1, wherein the method comprises the following steps:
determining at least one system parameter and at least one channel parameter of the MIMO wireless communication system; and
selecting an error-correction code from a plurality of built-in error-correction codes in the MIMO wireless communication system based on the at least one system parameter and the at least one channel parameter, such that the MIMO wireless communication system is able to perform encoding and decoding according to the selected error-correction code.

2. The method of claim 1, wherein the step of determining the at least one system parameter refers to determining the values of N and M.

3. The method of claim 2, wherein the step of determining the values of N and M comprises calculation of the ratio of M to N.

4. The method of claim 1, wherein the step of determining the at least one channel parameter involves determining the rank of the channel matrix of the communication channel.

5. The method of claim 4, wherein the error-correction code is selected based on the minimum value of the rank of the channel matrix, M and N.

6. The method of claim 4, wherein the error-correction code is selected based on N and the smaller value of the rank of the channel matrix and M.

7. The method of claim 4, wherein the error-correction code is selected based on M and the smaller value of the rank of the channel matrix and N.

8. The method of claim 1, wherein the at least one system parameter is related to the hardware setting of the MIMO wireless communication system.

9. The method of claim 1, wherein the at least one channel parameter is related to the communication channel between the input module and the output module.
